(19) United States
(12) Patent Application Publication
(10) Pub. No.: US 2010/0058466 A1
(43) Pub. Date: Mar. 4, 2010

(54) SYSTEMS AND METHODS FOR PROVIDING SECURITY FOR SOFTWARE APPLICATIONS

(75) Inventors: Troy A. Marchand, Nobleton (CA); Ravindar A. Bhavnani, Toronto (CA)

Correspondence Address: BERESKIN AND PARR LLP/S.E.N.C.R.L., s.r.l., 40 KING STREET WEST, BOX 401, TORONTO, ON, M5H 3Y2, CA

(73) Assignee: DUNDAS DATA VISUALIZATION, INC., Toronto (CA)

(21) Appl. No.: 12/552,595

(22) Filed: Sep. 2, 2009

Related U.S. Application Data
(60) Provisional application No. 61/093,775, filed on Sep. 3, 2008.

(51) Int. Cl. G06F 21/00

(52) U.S. Cl. 726/21

(57) ABSTRACT

The described embodiments relate generally to methods and systems for providing computer security. In one embodiment, a security system is provided for use with a core application configured to interact with at least one add-in module, and the add-in module being configured to provide at least one privilege. The security system includes a privilege registry configured to identify the at least one privilege and its corresponding add-in module and a privilege assignments table identifying a privilege assignment type for the at least one privilege and corresponding to at least one assignee.

### PRIORITY

This application claims priority from U.S. provisional patent application No. 61/093,775, filed Sep. 3, 2008, which is incorporated by referenced herein in its entirety.

### TECHNICAL FIELD

The described embodiments relate generally to methods and systems for providing computer security with particular, but by no means exclusive, application to service oriented software systems.

### BACKGROUND

Many software applications implement security processes to authenticate registered users, and control access by such registered users to privileges or functionality provided by the applications.

The applicants have recognized a need for improved systems and methods of providing security for software applications.

### BRIEF DESCRIPTION OF THE DRAWINGS

Embodiments are described in further detail below, by way of example only, with reference to the accompanying drawings, in which:

FIG. 1 is a block diagram of one implementation of a deployed software services implementation of the present disclosure.

FIG. 2A is a schematic illustration of one embodiment of example add-in module directory records containing exemplary data as may be stored in the add-in module directory of FIG. 1 at time A.

FIG. 2B is a schematic illustration of one embodiment of example add-in module directory records containing exemplary data as may be stored in the add-in module directory of FIG. 1 at time B.

FIG. 2C is a schematic illustration of one embodiment of example add-in module directory records containing exemplary data as may be stored in the add-in module directory of FIG. 1 at time C.

FIG. 3A is a schematic illustration of one embodiment of example user records containing exemplary data as may be stored in the users database of FIG. 1 at time A.

FIG. 3B is a schematic illustration of one embodiment of example user records containing exemplary data as may be stored in the users database of FIG. 1 at time B.

FIG. 3C is a schematic illustration of one embodiment of example user records containing exemplary data as may be stored in the users database of FIG. 1 at time C.

FIG. 4A is a schematic illustration of one embodiment of example group records containing exemplary data as may be stored in the groups database of FIG. 1 at time A.

FIG. 4B is a schematic illustration of one embodiment of example group records containing exemplary data as may be stored in the groups database of FIG. 1 at time B.

FIG. 4C is a schematic illustration of one embodiment of example group records containing exemplary data as may be stored in the groups database of FIG. 1 at time C.

FIG. 5A is a schematic illustration of one embodiment of example membership records containing exemplary data as may be stored in the membership database of FIG. 1 at time A.

FIG. 5B is a schematic illustration of one embodiment of example membership records containing exemplary data as may be stored in the membership database of FIG. 1 at time B.

FIG. 5C is a schematic illustration of one embodiment of example membership records containing exemplary data as may be stored in the membership database of FIG. 1 at time C.

FIG. 6A is a schematic illustration of one embodiment of example privilege registry records containing exemplary data as may be stored in the privilege registry of FIG. 1 at time A.

FIG. 6B is a schematic illustration of one embodiment of example privilege registry records containing exemplary data as may be stored in the privilege registry of FIG. 1 at time B.

FIG. 6C is a schematic illustration of one embodiment of example privilege registry records containing exemplary data as may be stored in the privilege registry of FIG. 1 at time C.

FIG. 7A is a schematic illustration of one embodiment of example privilege assignments table records containing exemplary data as may be stored in the privilege assignments table of FIG. 1 at time A.

FIG. 7B is a schematic illustration of one embodiment of example privilege assignments table records containing exemplary data as may be stored in the privilege assignments table of FIG. 1 at time B.

FIG. 7C is a schematic illustration of one embodiment of example privilege assignments table records containing exemplary data as may be stored in the privilege assignments table of FIG. 1 at time C.

FIG. 8 is a flowchart illustrating the sequence of events implemented by the deployed software services implementation of FIG. 1 when a user initiates a user request.

FIG. 9 is a flowchart illustrating the steps of installing an add-in module to the deployed software services implementation of FIG. 1.

FIG. 10 is an example screen shot of a user interface displayed on the user component of FIG. 1.

FIG. 11 is a flowchart of the sequence of steps involved in providing security for a core application in one embodiment of the present disclosure.

### DETAILED DESCRIPTION

The software applications noted above typically control a user's rights by defining a set of privileges which are then assigned to individual registered users. When a registered user attempts to perform an operation that requires one or more rights, the system checks to see if the user has been granted the appropriate privileges. If the user possesses the required privileges, the operation is executed; otherwise, the operation is refused.

To make it more convenient to manage a user's rights, some systems use the concept of roles or groups, which are assigned collections of privileges. A user's rights are determined by the roles or groups to which they are added. Because a role typically represents several privileges, a user may only need to be assigned to a few roles or groups.

Role-based rights management which has been incorporated into service applications may have limitations. For example, the set or definition of privileges may be static. The overall set of privileges used within or provided by the system needs to be known when the system is designed. Over time, the system may introduce new services that require new privileges. Because privileges need to be defined before they can be provided by the system, introducing new services may require an entirely new version of the software to be programmed and released.

Alternatively, systems that support a plug-in architecture may not need to release new versions of the system, by requiring that plug-ins apply a standardized set of rights (usually “create”, “update”, “read” and “delete”) to their objects or functionality. This “one size fits all” approach may be considered a compromise, since not all functionality can be ideally expressed in terms of “create”, “update”, “read” and “delete” actions.

Additionally, assigning a role to a user can typically only add to or detract from the user's set of privileges. As a result, with users who may be members of multiple different groups having different and/or conflicting rights with respect to some of the same privileges, it may be difficult for system administrators to ensure that users who are intended to possess certain privileges are permitted by the system to access or utilize such privileges. For example, some scenarios may require that certain users (eg: managers) always possess a specific privilege while simultaneously ensuring that certain users (eg: new employees) are always denied rights normally granted to more experienced employees.

The embodiments described herein may address in whole or in part some or all of the above-noted challenges. The described embodiments relate generally to systems and methods utilizing security software for authenticating registered users and controlling access by such registered users to privileges or functionality provided by the applications. When used herein, the terms “right” and “privilege” are intended to have similar meanings—both refer to the ability to access certain functionality in the software application.

One aspect of the technology described herein relates to a security system for use with a core application configured to interact with at least one add-in module, and the add-in module being configured to provide at least one privilege. The security system includes a privilege registry configured to identify the at least one privilege and its corresponding add-in module and a privilege assignments table identifying a privilege assignment type for the at least one privilege and corresponding to at least one assignee.

In some implementations, the privilege assignment type may be one of “denied”, “granted” and/or “always-granted”. The privilege assignment type may correspond to the assignee's permission to utilize the corresponding privilege. In some embodiments, upon installation of an add-in module, the core application may be configured to determine the at least one privilege corresponding to the add-in module.

Upon determining the at least one privilege, the core application may be configured to store in the privilege registry, privilege identification data identifying the at least one privilege.

The security system may also include an add-in module directory configured to identify the at least one add-in module.

Upon installation of the add-in module, the security system may also be configured to store, in the add-in module directory, add-in module identification data identifying the add-in module.

In some implementations, a user management system may also be provided which is configured to identify registered users. Each assignee may be a registered user.

The core application may include an add-in module manager configured to install the at least one add-in module.

Upon receiving a user request corresponding to a registered user and to a desired privilege, the add-in module may be configured to query the security system to determine the registered user's permission to utilize the privilege.

Other aspects of the invention may be directed towards a method of providing security for a core application configured to interact with at least one add-in module. The add-in module may be configured to provide at least one privilege, and the method includes;
(a) providing a privilege registry configured to identify the at least one privilege and its corresponding add-in module; and
(b) providing a privilege assignments table identifying a privilege assignment type for the at least one privilege and corresponding to at least one assignee.

The privilege assignment type may be denied, granted or always-granted. The privilege assignment type may correspond to the assignee's permission to utilize the corresponding privilege.

The method may also include providing a user management system configured to identify registered users. Each assignee may be a registered user.

The method may also include:
(c) receiving a request for a registered user to utilize a desired privilege; and
(d) querying the privilege assignments table to determine the registered user's permission to utilize the desired privilege.

Another aspect may be directed towards computer readable storage storing program code which, when executed by a processor, causes the processor to perform the method(s).

An alternate aspect may be directed towards an always-granted privilege assignment type for a user rights management system in which an assignee is identified as a member of a first user group and a second user group. The first user group is assigned the always-granted privilege assignment type for a privilege and the second user group is assigned a denied privilege assignment type for the privilege. The user rights management system may be configured to permit the assignee to utilize the privilege despite membership in the second group.

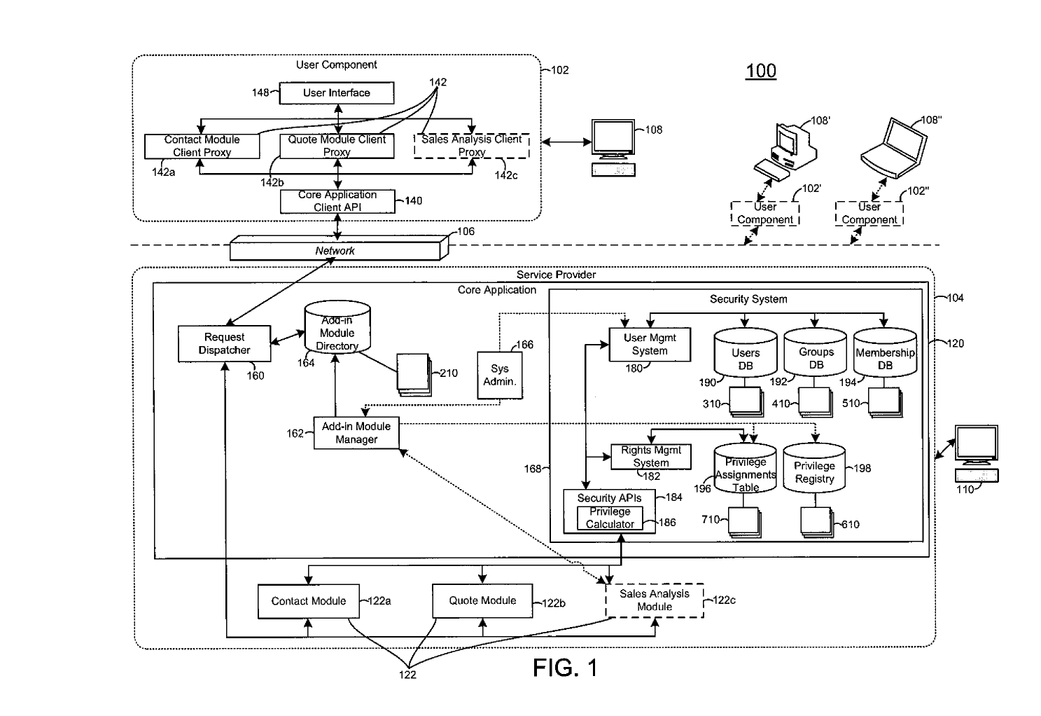

Referring to FIG. 1, a block diagram of a deployed software services application or implementation is shown generally as 100. The implementation comprises user component 102 and service provider 104 operatively connected by a computer network 106. User component 102 may run on client system 108, and corresponding user components 102′ and 102″ may optionally run on additional client systems such as 108′ and 108″, respectively in some embodiments. Service provider 104 may run on server system 110. Privileges available on service provider 104 are accessible to user component 102 connected to the same network 106.

Exemplary server system 110 and client system 108 comprise a number of components, including microprocessors. Microprocessors typically control the overall operation of computer systems. Microprocessors interact with additional subcomponents such as memory storage (which may include random access memory (RAM) and read-only memory (ROM), and persistent storage such as flash memory), display, network adapter and input device(s), for example, such as a keyboard, mouse, touchscreen (which may form part of the display) or touchpad. Network adapters allow connection to different types of networks (for example, Local Area Networks (LANs) as well as Wide Area Networks (WANs)), and may be wired (for example, through an Ethernet connection) or wireless (for example, through 802.11 Wireless Local Area Network (WLAN) or cellular standards). Operating system software used by a microprocessor is typically stored in a persistent store such as flash memory or read-only memory (ROM) or similar storage. Those skilled in the art will appreciate that the operating system, specific software components, or parts thereof, may be temporarily loaded into a volatile store such as RAM. Microprocessors, in addition to operating system functions, enable execution of software components. In the exemplary embodiment in FIG. 1, client system 108 executes user component 102 and server system 110 executes service provider 104.

From a high level perspective, service provider 104 provides functionality to client systems 108, 108′, 108″ running user components 102, 102′, 102″. An example of the use of service provider 104 includes a customer relationship management application (CRM), whereby users interacting with client system 108 access the customer management functionality provided by service provider 104 to store, view, and update customer information.

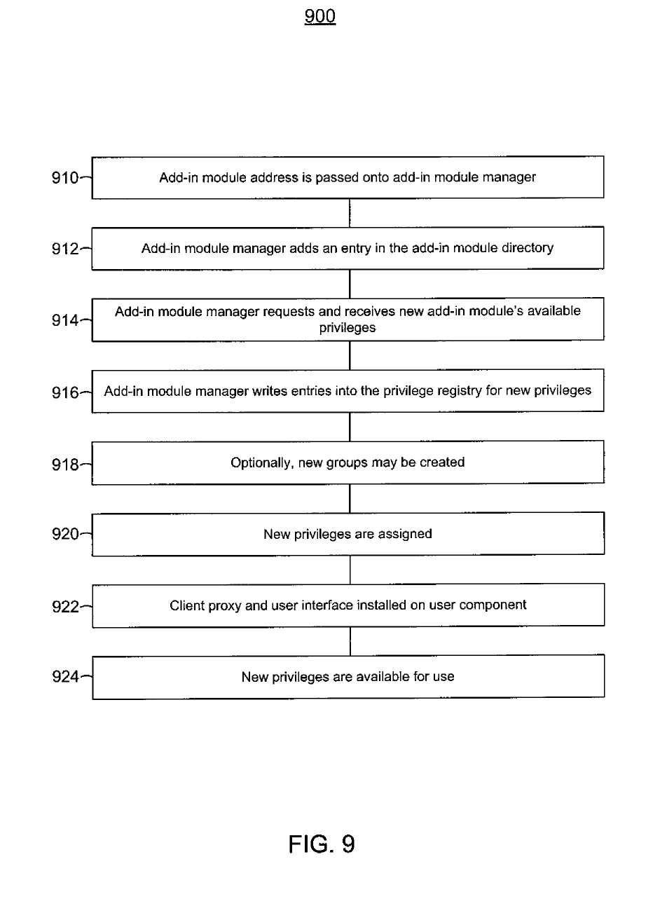

Service provider 104 includes the core application 120 and typically at least one add-in module 122. The core application 120 receives user requests from client systems 108 and offers centralized management of security. Add-in modules 122 are software modules that implement specific privileges, which may be desired by a user. For example, an add-in module 122 may offer the privilege of streaming a song. In such case, the core application might only allow the streaming to take place if the user was assigned the privilege of streaming music. The exemplary embodiment of FIG. 1 illustrates a CRM system. In the example, there are two installed add-in modules: contact module 122a for managing sales contacts, and quote module 122b for managing sales quotes. The contact module 122a may, for example, provide users with the privileges of viewing, adding, editing or deleting contacts. In a system where sales representatives may create quotes that are not official until approved, the quote module 122b may, for example, provide users with the ability to view, create, approve, unapprove and delete quotes. A third add-in module, the sales analysis module 122c (illustrated in dotted outline), will be installed as is described below and in reference to FIG. 9. As will be understood, a service provider 104 may contain additional or different add-in modules 122 depending on the desired application.

To identify the availability of privileges from add-in modules 122, add-in modules 122 may also be programmatically enabled to communicate the availability of their respective privileges to requesting software components.

User component 102 facilitates the usage of add-in module privileges by including core application client API 140, user interface 148, and typically at least one add-in module client proxy 142. Add-in module client proxies 142 are operatively connected to the user interface 148 and the core application client API 140. Each add-in module client proxy 142 corresponds to an add-in module 122 in the service provider 104 such that privileges made available by the add-in module 122 may be mirrored for access through the client proxy 142 (programmatically or otherwise) by user interface 148 (in the exemplary configuration in FIG. 1, contact module client proxy 142a corresponds to contact module 122a; quote module client proxy 142b corresponds to quote module 122b; and sales analysis client proxy 142c will correspond to sales analysis module 122c when both are installed). Client proxies 142 facilitate access to add-in module privileges by packaging user requests from the user interface 148 for desired privileges into privilege-related proxy requests understood by core application client API 140. These requests are then sent from the client application client API 140 to the service provider 104 via computer network 106.

The core application 120 may include a request dispatcher 160, an add-in module manager 162, an add-in module directory 164, a system administration component 166 and a security system 168.

As is described below, system administration component 166 may provide functionality related to the administration of service provider 104. This may include the management of users and their membership in groups, as well as the management of add-in modules 122. As will be discussed in greater detail below, human system administrators may access this system component 166. System administration component 166 is operatively coupled to the add-in module manager 162 and the user management system 180.

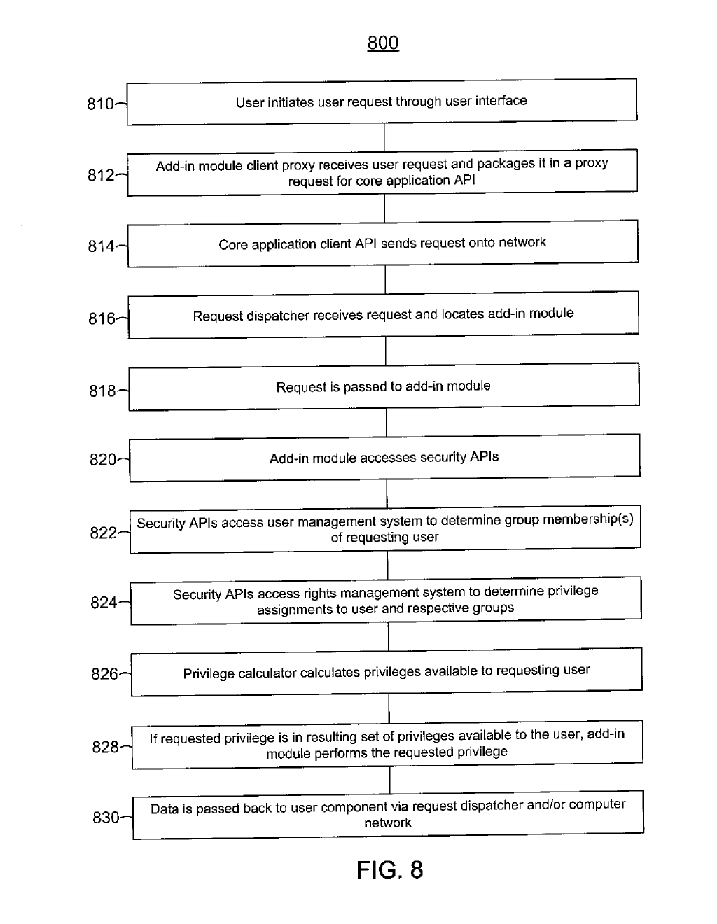

In relation to user requests of a desired privilege above, request dispatcher 160 receives such requests from core application client API 140 across the computer network 106. As will be discussed below in reference to FIG. 8, when request dispatcher 160 receives a request to perform an operation from the core application API 140, it may look for a record 210 in the add-in module directory 164 corresponding to that add-in module 122. If the add-in module 122 exists, the request dispatcher 160 forwards the request to the appropriate add-in module 122.

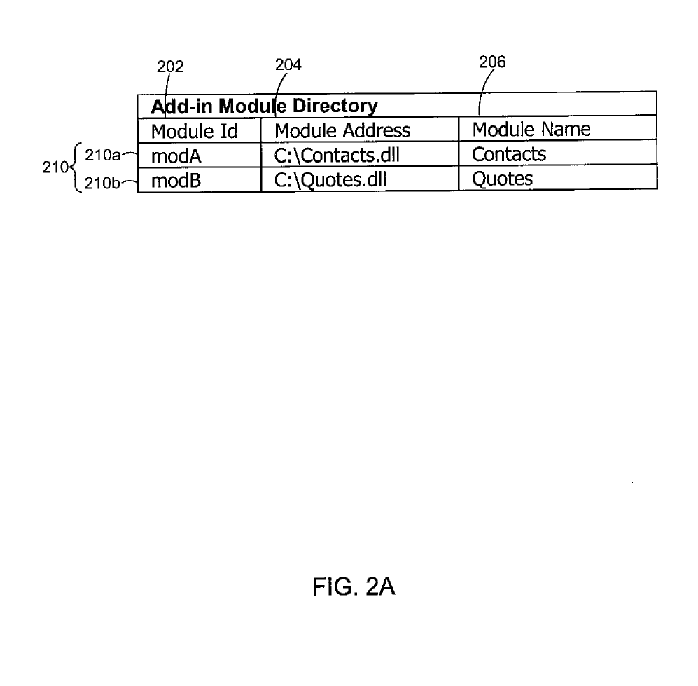

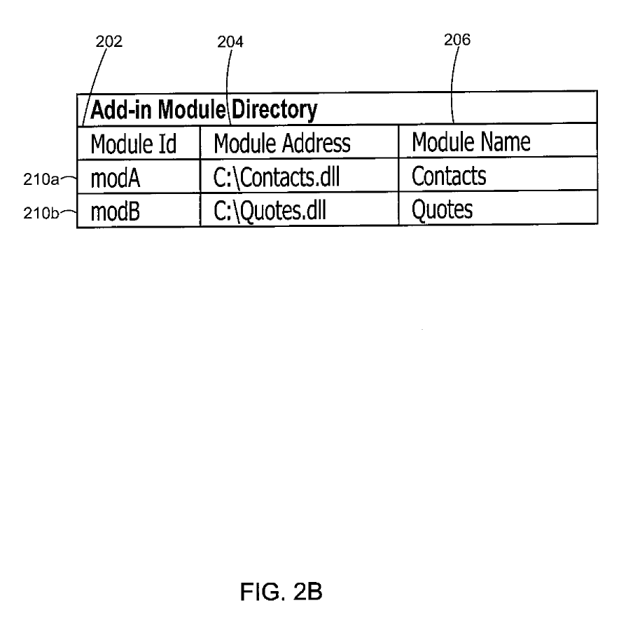

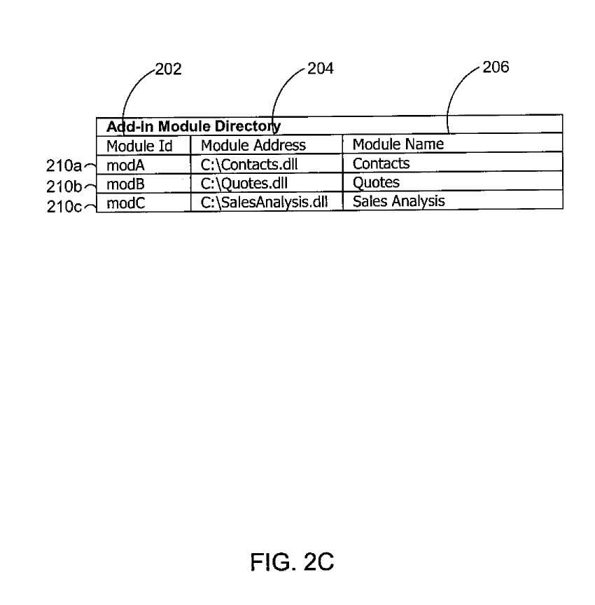

Referring briefly to FIG. 2A, illustrated therein is a schematic illustration of example add-in module directory records 210 containing exemplary data as may be stored in add-in module directory 164. Each record 210 corresponds to one add-in module 122. The data stored in each record may include module identifier 202, module address 204 (typically a path to the hard disk or a network address to where the add-in module 122's program code is stored) and the module name 206.

Upon receiving a request, an add-in module 122 determines whether the requesting user has permission to utilize the requested privilege by accessing security system 168. Security system 168 provides the security features offered by core application 120 whereby privileges provided by add-in modules 122 are only utilized by users with proper permission. It includes user management system 180 for organizing registered users and rights management system 182 for managing accessible privileges and their assignment. The security features are made available through the security application programming interfaces (APIs) 184.

User management system 180 is configured to utilize data stored in users database 190, groups database 192 and membership database 194. User management system 180 is also operatively coupled to security APIs 184 to provide group membership status of registered users to add-in modules 122.

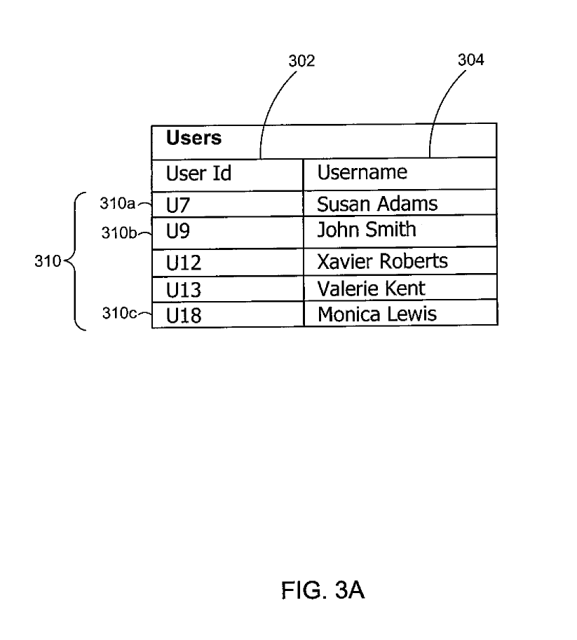

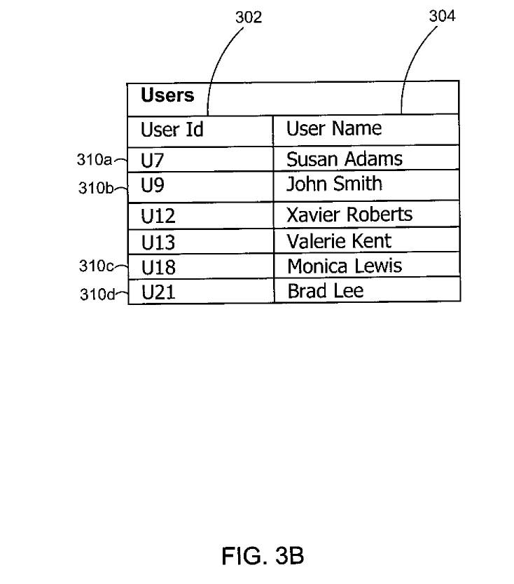

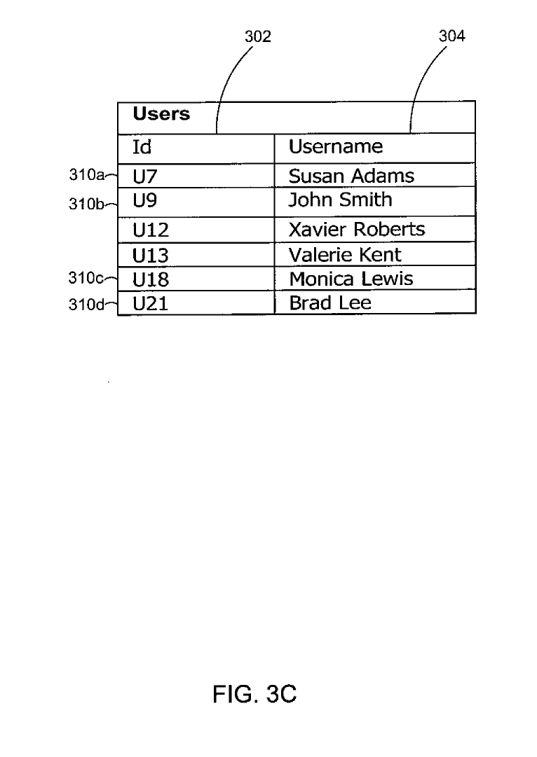

Users database 190 stores a list of registered users that can access operations provided by add-in modules 122 in the service provider 104. Referring briefly to FIG. 3A, illustrated therein is a schematic illustration of example user records 310 containing exemplary data as may be stored in users database 190. User records 310 typically comprise user identifier 302 and a username 304. User records 310 may also store password data (not shown) for implementing a user authentication system if such records are used to verify the identity of the user (e.g., for login purposes).

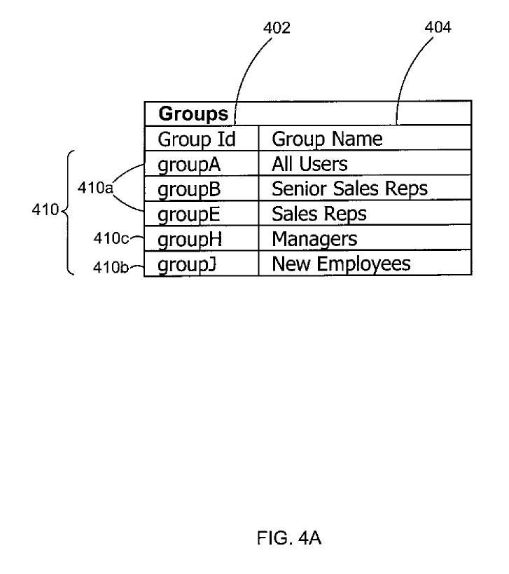

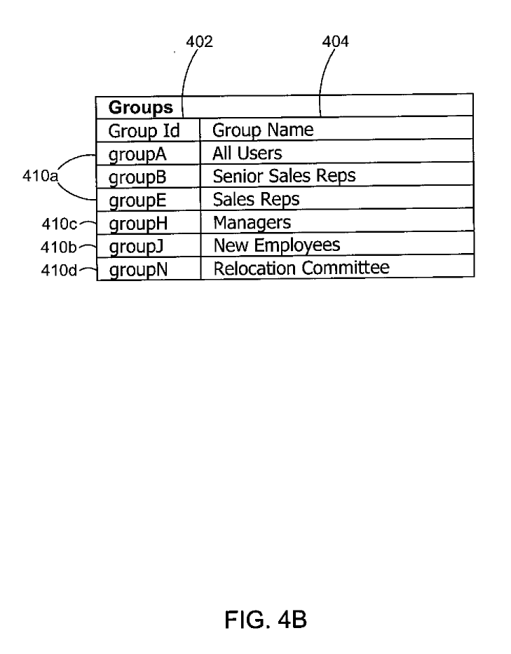

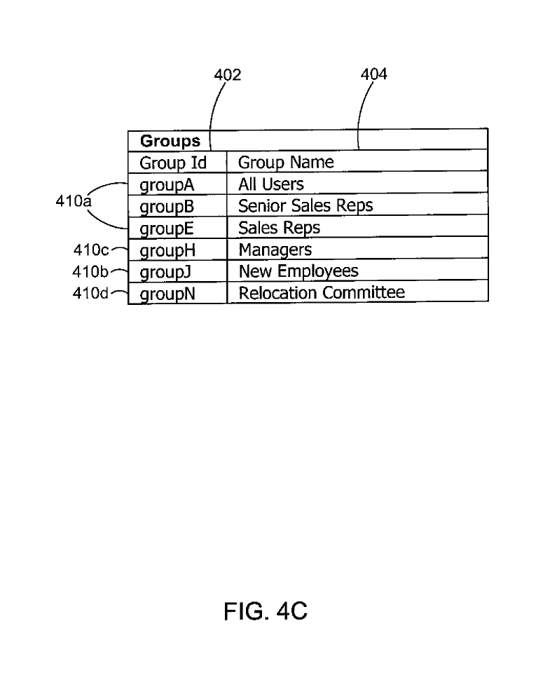

Groups database 192 stores a list of groups used to identify users with a common required functionality and/or security-related characteristic. For example, these could be functional groups as may be identified and organized by the human resources personnel of an organization such as a “marketing” or “accounting” group. Marketing group members might, for example, require privileges to access secretive product launch campaign data, but could be denied privileges to view expenses claimed by fellow employees. Conversely, accounting group members would need privileges to view expenses claimed by fellow employees, but should be denied privileges to access secretive product launch data. Groups can further be used to divide users in other ways, such as the formation of a social committee group across functional lines of an organization for the organizing of social events. As an example, such a committee might need privileges to view a social committee budget. Referring briefly to FIG. 4A, illustrated therein is a schematic illustration of example groups database records 410 containing exemplary data as may be stored in groups database 192. Group records typically include a group identifier 402 and a group name 404.

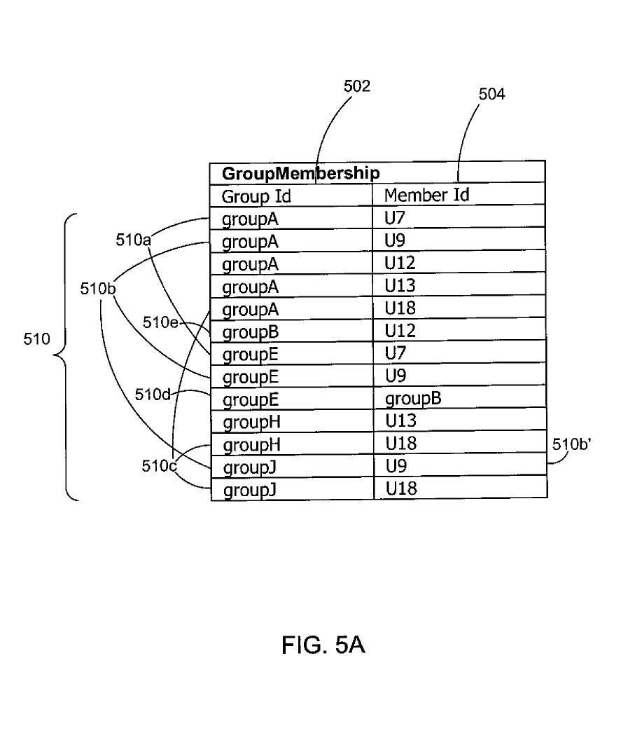

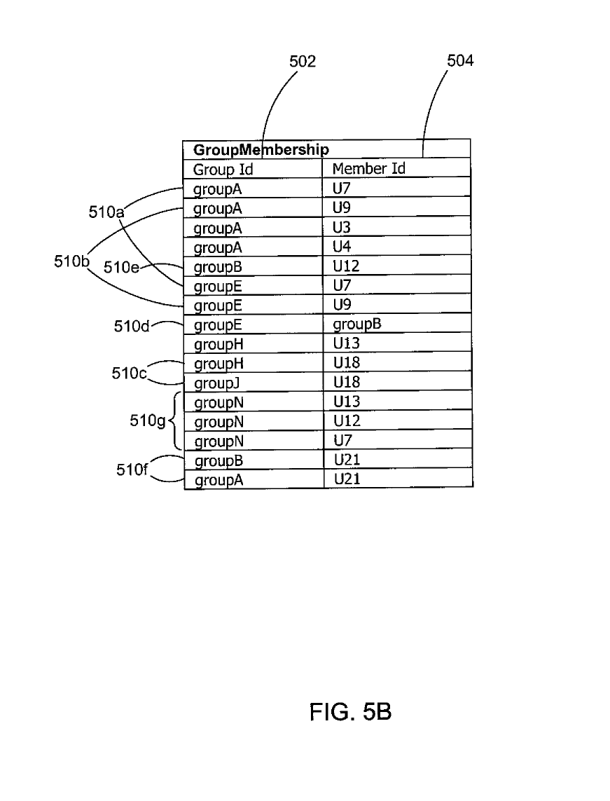

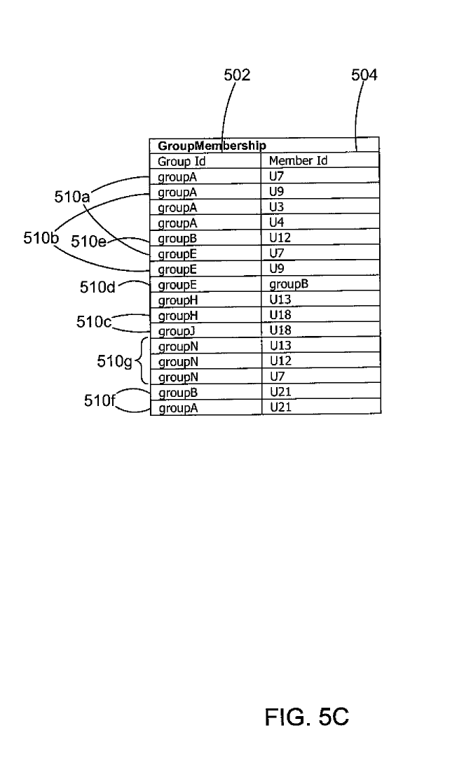

Membership database 194 stores the data indicative of membership in groups. For every member of a group, a membership record 510 may be provided. Membership database 194 may be configured to permit nested groups such that both users and groups may be members of groups. For example, a senior sales representatives group would be a member of a sales representatives group, as the senior sales representatives should typically retain all of the privileges of the sales representatives. Referring briefly to FIG. 5A, illustrated therein is a schematic illustration of example membership database records 510 containing exemplary data as may be stored in membership database 194. Membership records 510 typically contain a group identifier 502 indicating the group for which the member is in, and a member identifier 504 indicating the identifier of the member in the group. If the member is a user, the member identifier 504 may correspond to the user identifier 302 of the user record 310 corresponding to the user. If the member is a group, the member identifier 504 may correspond to the group identifier 402 of the group record 410 for the group.

Turning now to the rights management system 182 in the security system 168, the rights management system 182 may contain privilege registry 198. Privilege registry 198 stores the privileges provided by add-in modules 122. In doing so, it forms part of the security system 168 that enables access to privileges provided by add-in modules 122 while allowing the add-in modules 122 to define the specific privileges themselves.

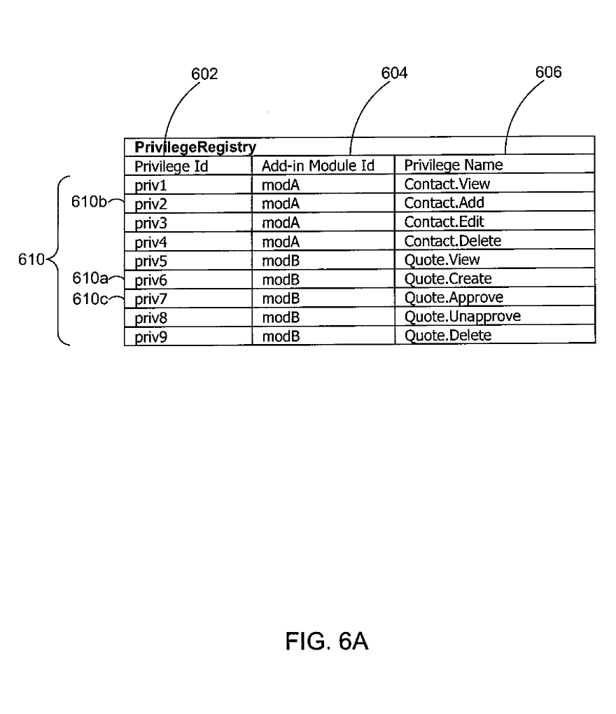

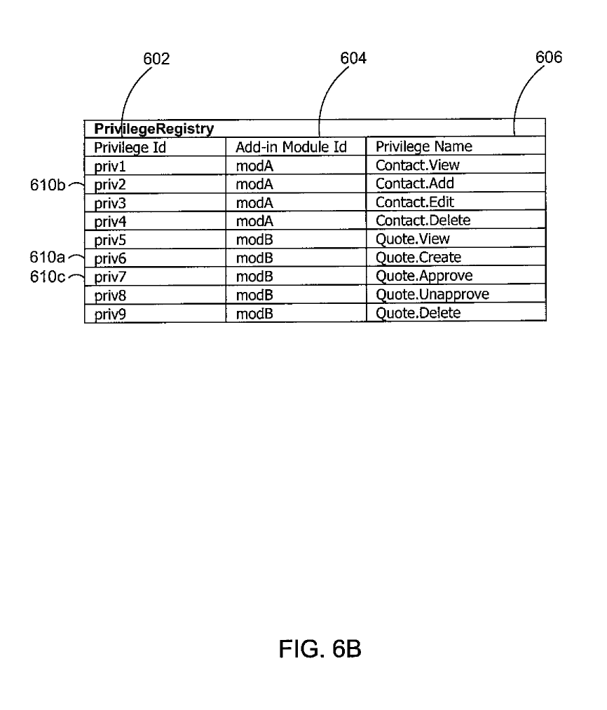

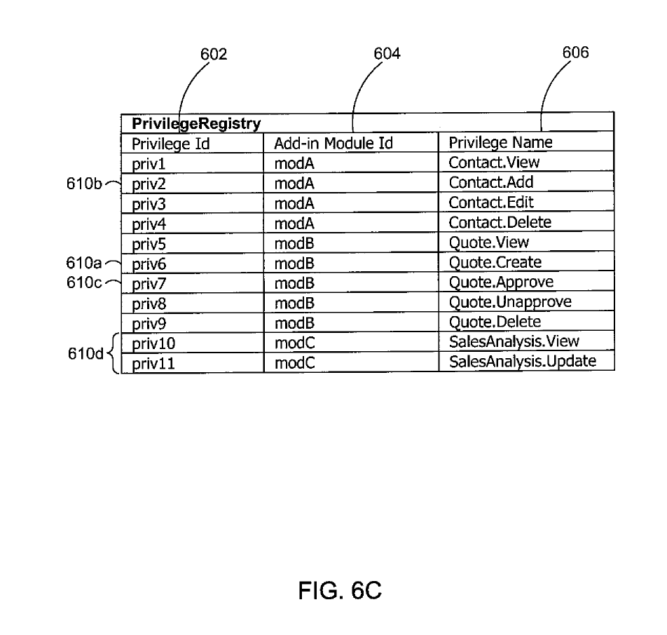

Referring briefly to FIG. 6A, illustrated therein is a schematic illustration of example privilege registry records 610 containing exemplary data as may be stored in privilege registry 198. Each privilege record 610 may correspond to an add-in module 122 that is installed in the add-in module directory 164. Privilege registry records may typically contain privilege identifier 602, the add-in module identifier 604 and the privilege name 606. As is discussed below in reference to FIG. 9, the privilege registry records 610 are entered in the privilege registry 198 by add-in module manager 162 when the add-in modules 122 are installed.

The privilege assignments table 196 stores records indicating the assignment of privileges to users or groups. When an add-in module 122 needs to determine a set of privileges available to a particular registered user, this table is queried. For every privilege assigned to a user or a group, a record 710 may be provided in the privilege assignments table 196.

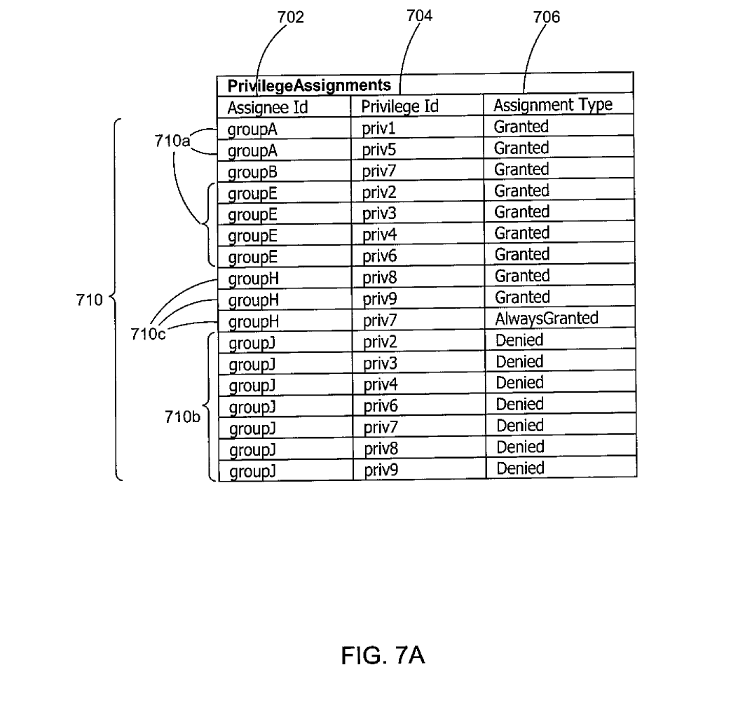

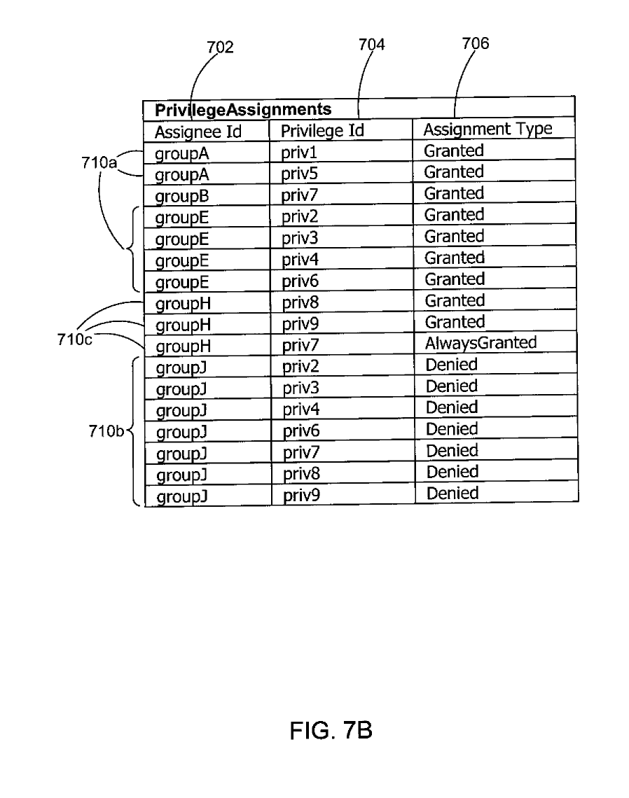

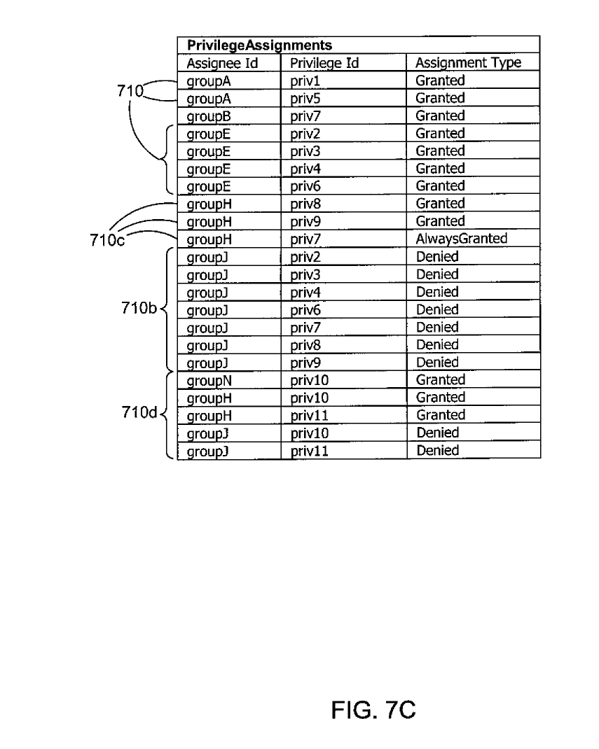

Referring briefly to FIG. 7A, illustrated therein is a schematic illustration of example privilege assignment records containing exemplary data as may be stored in privilege assignment table 196. Privilege assignment records 710 may typically contain an assignee identifier 702, a privilege identifier 704, and an assignment type 706. The assignee identifier 702 corresponds to the identifier (either group identifier 402 or user identifier 302) of the assignee of the privilege. The assignment type 706 may typically be one of: “granted”, “denied”, or “always-granted”. However, other assignment types may be implemented as necessary. As is discussed below, the assignment type affects the resulting set of privileges available to the user.

In alternate embodiments, an additional column entitled “target identifier” may be provided to identify a more specific assignment of privileges to specific objects. For example, a target identifier may be provided to identify a specific contact record (eg. the home address of a client) that only certain groups or users have the privilege to view.

It will be understood by a person skilled in the art that although each of users database 190, groups database 192, membership database 194, privilege assignments table 196, privilege registry 198 and add-in module directory 164 are illustrated in FIG. 1 as separate stores, they can be stored together as separate tables within the same or multiple databases both locally and/or remotely. Additionally, other persistent storage methods such as encrypted files may also be used to effect persistent storage.

### Examples

### Receiving User Requests for Desired Privileges

Simultaneously turning now to FIGS. 2A, 3A, 4A, 5A, 6A, and 7A illustrated therein is exemplary data as may be accessed by a deployed software services implementation 100 at a point in time, A. The data in FIGS. 3A, 4A and 5A correspond to five exemplary users, five exemplary groups and their respective group memberships. The data in FIGS. 2A, 6A and 7A correspond to the respective privileges provided by the two installed add-in modules: contact module 122a and quote module 122b, and the assignment of their respective privileges to various groups. At time A, the sales analysis module 122c has not yet been installed.

The determination of a user's available privileges is performed by privilege calculator 186. The calculation may be performed for a set of privileges assigned to a user as follows: privileges with the assignment type 706 of “granted” are added to the user's set of available privileges. Then, privileges with the assignment type 706 of “denied” are taken away from the set of available privileges. (If a “denied” privilege has no corresponding privilege in the set of available privileges, there is no effect.) Subsequently, the privileges with assignment type 706 of “always-granted” are added to the set to arrive at the resulting set of privileges available to the user.

To more clearly illustrate the operation of privilege calculator 186 in the context of a user request, the calculation of privileges available to Susan Adams (user “U7” of record 310a), John Smith (user “U9” of record 310b) and Monica Lewis (user “U18” of record 310c) will be examined.

As will be explained below, Susan Adams is determined (in reference to records 510a in FIG. 5A) to be a part of the “All Users” (groupA) and “Sales Reps” (groupE) groups. Referring to FIG. 7A, the corresponding “granted” privileges are: priv1, priv5, priv2, priv3, priv4 and priv6 (records 710a). Since there are no privileges “denied” or “always-granted”, the privileges in the “granted” set mentioned above are available to Susan Adams.

John Smith (U9) is a member of the “All Users” (groupA), “Sales Reps” (groupE) and “New Employees” (groupJ) groups. (John is in the “New Employees” group because he has only been employed for a short period of time and certain privileges are denied until he passes probation.) Performing again the privilege calculation in reference to FIG. 7A, the set of “granted” privileges are priv1, priv5, priv2, priv3, priv4 and priv6 (records 710a). However, because John is also a member of the “News Employees” (groupJ) group, he also has priv2, priv3, priv4, priv6, priv7, priv8 and priv9 “denied” (records 710b). Hence, the initially “granted” privileges of priv2, priv3, priv4 and priv6 are taken away from the set of available privileges. As there are no assigned privileges with the assignment type of “always-granted”, the set of available privileges is what remains after the “denied” privileges are taken away: namely priv1 and priv5. If, for example, John Smith attempts to “add a contact” (priv2 in record 610b of FIG. 6A, “Contact.Add”), he will be denied because the privilege is not in the resulting set of privileges available to John.

A more complicated example illustrates the usage of the “always-granted” assignment type. Monica Lewis (U18) is determined (in reference to records 510c of FIG. 5A) to be a member of the “All Users” (groupA), “Managers” (groupH), and “New Employees” (groupJ) groups. Again performing the privilege calculation with regards to FIG. 7A, the “granted” privileges contain priv1, priv5, priv8 and priv9. Because Monica Lewis is also a “New Employee”, priv8 and priv9 are taken away. However, in the “Managers” (groupH) group, priv7 has an “always-granted” assignment type. As such, priv7 is added after the denied privileges have been taken away to provide a resulting set of privileges that contain priv1, priv5 and priv7. Since priv7 corresponds to the “approve a quote” privilege in the privilege registry (record 610c in FIG. 6A, “Quote.Approve”), Monica would be permitted to “approve a quote”.

Illustrated above is one potential benefit of the “always-granted” privilege. Traditional privilege administration systems only contain two privileges: “granted”, or “denied”. But often groups grant and deny the same privilege for different valid reasons. Here, the “Managers” group grants a privilege (“priv7”) because of Monica's role in the organization. At the same time, she is unintentionally denied the same privilege as a “New Employee” because of her short tenure in the organization. The “always-granted” assignment type provides a mechanism for the resolution of such a conflict.

Additionally, the “always-granted” assignment type may also provide a way to resolve a conflict after it has been discovered. That is, it may be the case that privilege assignment tables are so long that users could be placed in groups on a basis of what is thought to be non-overlapping privileges. In traditional systems with only two assignment types, there may be no easy way of resolving such a conflict. In the example, it may be the case that historically, new employees were never included in the “Managers” group. However, upon evolution of the “New Employees” group, certain privileges were denied to the group for security reasons. Subsequently, when adding a new manager to both groups, a privilege might be unintentionally denied. As a result, setting the assignment type of such a privilege to “always-granted” could prevent future accidental denials.

FIG. 8 contains a flowchart illustrating the steps of a method, referred to generally as 800, which may be undertaken when a user initiates a user request. An example with user Susan Adams (U7, referenced above) requesting to “create a quote” (record 610a in FIG. 6A, “Quote.Create”) at time A will be walked through to illustrate the method.

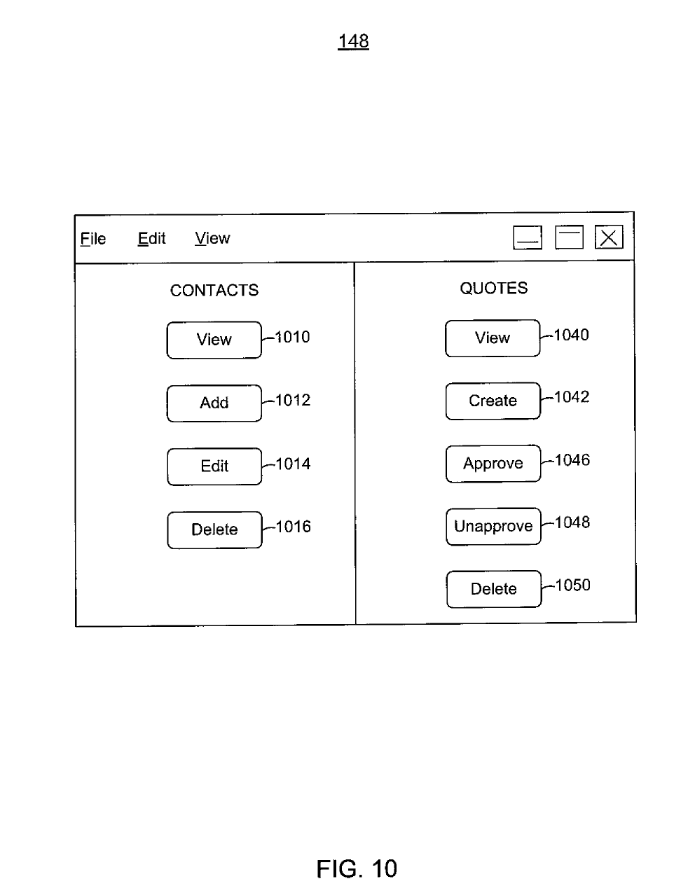

First, a user may initiate a user request through the user interface 148 (Block 810). In the example, Susan Adams (U7) selects the “Create” button 1042 on the “QUOTES” portion of her user interface 148 in FIG. 10.

The request is received by an add-in module client proxy 142, which then packages it in a proxy request for core application API 140 (Block 812). As discussed earlier, each client proxy 142 corresponds to an add-in module 122 for which it typically mirrors the available privileges of add-in module 122 to make them accessible to user interface 148. In facilitating access to the add-in module 122's privileges, the client proxy 142 receives the user request and packages it with information identifying the specific desired privilege and the requesting user to generate a proxy request. In the example being discussed, the user request is received by quote module client proxy 142b, which then packages it in a proxy request identifying Susan Adam (U7) as the requesting user and the “create a quote” (record 610a in FIG. 6A, “Quote.Create”) privilege as the desired privilege. The proxy request is then sent to core application client API 140.

The core application client API 140 then sends the request to the network 106 (Block 814).

Moving now to the service provider 104, the request dispatcher 160 receives the request from network 106 and looks up the address of add-in module 122 in add-in module directory 164 to locate the add-in module 122 referenced in the proxy request (Block 816). For example, Susan Adam's request is received by request dispatcher 160 and it determines the address of the quote module 122b by looking up record 210b (of FIG. 2A) in add-in module directory 164.

The request may then be passed to the corresponding add-in module 122 (Block 818). In the example, Susan Adam's request may be passed onto quote module 122b. In alternate embodiments, the user request may not need to be passed to the add-in module 122 for the determination of user security. In such an embodiment, the request dispatcher 160 may be operatively connected to the security system 168 to access the set of available privileges for the requesting user, and only pass on the request to the add-in module 122 if the privilege is permitted for the given user. Such an embodiment may be less efficient than the embodiment currently described as it may increase the workload of the request dispatcher by requiring it to perform additional functionality. Increased workload may reduce the responsiveness of the service provider 104.

The add-in module 122 may then access security APIs 184 to determine if the requesting user has the permission to utilize the requested privilege (Block 820). In the example, the quote module 122b accesses the security APIs 184 to determine if Susan Adams (U7) has the privilege to “create a quote” (record 610a in FIG. 6A, “Quote.Create”). In certain embodiments, it may be possible that same add-in modules provide privileges that are not security-protected. In such case, look-ups into the security system may be bypassed and the add-in module may perform the privilege as requested.

In turn, the security APIs 184 access user management system 180 to determine the group membership(s) of the requesting user (Block 822). In the example, the security APIs 184 determine the group membership(s) for Susan Adams (U7) by accessing user management system 180. Referring to FIG. 5A, Susan Adams (U7) is a member of two groups (records 510a): “All Users” (groupA) and “Sales Reps” (groupE).

The security APIs 184 may also access the rights management system to determine the privileges assigned to the user and the user's respective groups (Block 824). In the example, security APIs 184 access rights management system 182 to determine the privileges assigned to Susan Adam (U7)'s groups. Referring to FIG. 7A, the respective privileges for each group are obtained.

It will be understood that although no records indicating an assignment of privileges to users directly are illustrated in FIG. 7A, such assignments may nevertheless be possible and is within contemplated embodiments.

The privilege calculator 186 may then proceed to calculate privileges available to the requesting user (Block 826). As described earlier, the resulting set of privileges at time A for Susan Adams (U7) are: priv1, priv5, priv2, priv3, priv4 and priv6 (records 710a).

If the requested privilege is in the resulting set of privileges available to the user, the add-in module 122 performs the requested privilege (Block 828). For Susan Adams (U7), it is determined that the “create a quote” privilege (priv6 in record 610a of FIG. 6A, “Quote.Create”) is permitted for Susan Adams. She is thus permitted to “create a quote”.

The add-in module 122 may also pass back response data to user component 102 through request dispatcher 160 and network 106 (Block 830). Such response data may correspond to a denial of the privilege request (if appropriate), or some or all of the data resulting from the implementation of the privilege functionality, if the privilege is granted. Upon receiving response data from network 106, core application client API 140 passes such data to user interface 148 through client proxy 142 to inform the requesting user. In the example, after quote module 122b has created a quote for Susan Adams (U7), a confirmation message of “quote created successfully” is sent to user component 102 through request dispatcher 160 and network 106. Client application API 140 receives the response message and then sends the message to user interface 148 through quote module client proxy 142b. The message is then displayed to user Susan Adams (U7).

In alternate embodiments, add-in modules 122 may access network 106 directly and pass back data without accessing request dispatcher 160. As a further alternate embodiment, an additional component within the core application may be provided to relay response data back to user component 102. For the currently described embodiment, it will be understood that all information necessary to execute the requested privilege is passed to the add-in module 122 upon the transfer of the initial request. Nevertheless, add-in module 122 may access request dispatcher 160 to pass back response data after execution of the privilege.

### Role of the System Administrator

Turning now to the administration of a deployed software services implementation 100, two functions will be described: (1) the management of users, groups and membership in groups and (2) the management of add-in modules 122 and their associated privileges.

Referring again to FIG. 1, human system administrators can typically access the system administration component 166 to add, delete, and update membership in groups. Any such changes will be reflected in the users database 190, groups database 192 and membership database 194. Since privileges are typically assigned to groups as earlier noted, it will affect the privileges available to users. FIGS. 2B, 3B, 4B, 5B, 6B, and 7B illustrate the point in time, B, subsequent to time A.

It should be understood that the user management functionality of system administration component 166 is not limited to the adding, deleting or updating of users or membership in groups. For example, in other embodiments, the users database records 310 may contain additional columns which system administration component 166 may be able to update.

At time B, user John Smith (U9) has now passed his probationary period. As such, he is removed from the “New Employees” group (groupJ) by the human system administrator utilizing the system administrator component 166 to update the data stored in the membership database 194. Referring now to FIG. 5B, it can be seen that the record 510b′ in FIG. 5A placing John Smith (U9) in the “New Employees” group (groupJ) has been deleted and is no longer in the membership database 194. When John Smith now initiates a user request, the privileges denied to “New Employees” no longer apply. As such, should he request the privilege of “adding a contact”, he would now be able to utilize that privilege.

A second example illustrates the addition of a new Senior Sales Rep named Brad Lee at time B. Referring to FIG. 3B, record 310d is added to the users database 190 for new user Brad Lee (user identifier U21). Referring now to FIG. 5B, records 510f have been added to indicate that user Brad Lee is a part of the “All Users” (groupA) and the “Senior Sales Reps” (groupB) groups. By virtue of record 510d, the “Senior Sales Reps” (groupB) group is a nested group within the “Sales Reps” (groupE) group. As such, when Brad Lee initiates a user request, the privileges assigned to both groups affect the calculation of the resulting set of privileges available to him.

A third example of system administration may be the addition of a new group named “Relocation Committee”. The purpose of the committee may be to determine an optimal relocation destination. The committee may be composed of members of the organization with different functional roles. Referring to FIG. 4B, record 410d is added to the groups database 192 for new group (groupN). Referring now to FIG. 5B, records 510g have been added to indicate that Susan Adams (U7), Xavier Roberts (U12), and Valerie Kent (U13) have been added to the “Relocation Committee” group (groupN). When any of these registered users request an operation, the privileges assigned to the new group will be additionally reflected in the privilege calculation that determines the resulting set of available privileges for each respective registered user.

The discussion now turns to the system administration function of add-in module 122 management and associated privileges. System administration component 166 can be used to add and delete add-in modules 122 as well as assign privileges provided by the add-in modules 122. It should be understood that while the illustrative example of adding an add-in module 122 is discussed, add-in module 122 management is not limited solely to addition or deletion of add-in modules 122 or the assignment of privileges. For example, the system administration component 166 may be configured to interface with additional components in the core application 120 such as the request dispatcher 160 to optimize the operation of the service provider 104. FIGS. 2C, 3C, 4C, 5C, 6C and 7C illustrate the state of the databases 164, 190, 192, 194, 198 and 196 respectively at time C after the system administrator has added a new add-in module 122.

Referring again to FIG. 1, the system administration module 166 is accessed by a human system administrator to initiate the addition of a new sales analysis module 122c (in dotted outline in FIG. 1). The sales analysis module 122c may provide, for example, analytical tools to determine geographical concentration of sales. As such, it may be a useful tool for managers to use in determining where to deploy sales staff. Likewise, it may also be a useful tool for the relocation committee to use in determining the most optimal place to relocate. FIG. 9 contains a flowchart illustrating the method, shown generally as 900, of installing an add-in module 122.

The process may be initiated when the system administration component 166 receives the address of an add-in module 122 and passes it onto the add-in module manager 162 (Block 910). Such process may be triggered by a human administrator. In the example, the system administration module 166 receives the address (e.g., C:\SalesAnalysis.dll) of the sales analysis module 122c and passes it to the add-in module manager 162 (AIM manager).

The AIM manager 162 then adds an entry into the add-in module directory 164 for the received add-in module 122 (Block 912). In the example, record 210c in FIG. 2C illustrates the addition of the new record for the sales analysis module 122c in the add-in module directory 164.

The AIM manager 162 may then request and receive data identifying the new add-in module's available privileges from the add-in module 122 (Block 914). In the present example of adding the sales analysis module 122c, the AIM manager 162 is programmatically enabled to request the sales analysis module (122c) to identify its privileges and the sales analysis module 122c is programmatically enabled to respond.

AIM manager 162 may write entries into the privilege registry 198 corresponding to the privileges of the new add-in module 122 (Block 916). In the example, privileges received from sales analysis module 122c are written into the privilege registry 198. Referring to FIG. 6C, records 610d illustrate the addition of two new privileges: “SalesAnalysis.View” (priv10) and “SalesAnalysis.Update” (priv11).

At this point, the system administration component 166 may optionally be configured to automatically add a new group for organizing users who are to utilize the privileges of the new add-in module 122 (Block 918). While the creation of a group can be done at any time, doing so at this stage is particularly advantageous because the new privileges have just been installed, and the existing group structure may be inadequate to achieve the desired distribution of privileges.

The privileges from the new add-in module 122 may be assigned to users or groups (Block 920). This may be accomplished when the human system administrator accesses the system administration component 166 with the privilege assignment information. The system administration component 166 in turn may instruct the add-in module manager 162 to add new records 710 into the privilege assignments table 196. In the example, records 710d of FIG. 7C indicate the additions to the privilege assignments table 196 for the “SalesAnalysis.View” (priv10) and “SalesAnalysis.Update” (priv11) privileges. “Managers” will need to view (priv10) and update (priv11) the sales analysis for the assignment of sales representatives. As such, both of these privileges are “granted” to the “Managers” group (groupH). Also, since “SalesAnalysis.View” (priv10) may be useful in determining an optimal relocation destination, the privilege (priv10) may also be granted to the “Relocation Committee” group (groupN). However, such sensitive sales analytical information might need to be restricted from viewing by new employees. Thus, the “New Employees” group (groupJ) is denied the new privileges.

Before an add-in module can be used, its corresponding client proxy 142 and an associated updated user interface 148 will typically need to be installed on user component 102 (Block 922). In the example, sales analysis client proxy 142c (in dotted outline on FIG. 1) is installed on user component 102 and an updated user interface 148 is also installed.

The privileges provided by the new add-in modules may be available for use (Block 924). In the example, certain registered users may be able to access the “view sales analysis” (priv10) and “update sales analysis” (priv11) privileges.

Although the user interface 148 and client proxies 142 are illustrated as separate software components in FIG. 1, the two components may be more tightly coupled or more loosely coupled. For example, the user interface and client proxies may be constructed in a more integrated way such that the user interface 148 contains all client proxies 142 and that upon an addition of an add-in module 122 all client proxies 142 and user interface 148 will have to be reinstalled. Conversely, user interface 148 can be constructed in a less integrated way such that the user interface is not dependent upon any knowledge of the client proxy. In such a construction, the user interface 148 may not need to be updated when a new add-in module 122 is installed—only a new client proxy 142 may need to be installed.

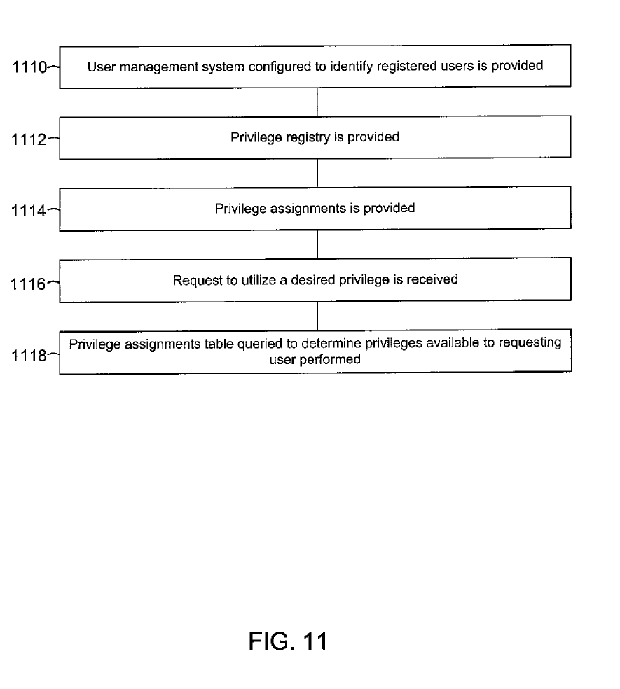

FIG. 11 illustrates a flowchart of the sequence of steps involved in providing security for a core application 104 configured to interact with at least one add-in module 122, the add-in module 122 being configured to provide at least one privilege.

At Block 1110, user management system 180 configured to identify registered users is provided. As discussed above, user management system 180 manages the registered users of the system and their respective group memberships. It references users database 190, groups database 192 and membership database 194. Registered users are stored as records (310 in FIG. 3A) in users database 190, and their respective group memberships are stored as records (510 in FIG. 5A) in membership database 194.

At Block 1112, a privilege registry 198 configured to identify the at least one privilege and its corresponding add-in module 122 is provided. As discussed above, privilege registry 198 stores records indicating the privileges made available by an add-in module 122. The privilege records (610 in FIG. 6A) are written when an add-in module 122 is installed.

At Block 1114, a privilege assignments table 196 identifying a privilege assignments type for the at least one privilege and corresponding to at least one assignee is provided. As discussed above privilege assignments table 196 stores records indicating the assignment of privileges to users or groups. The assignment type (706 in FIG. 7A), for example, can be one of “granted”, “denied” or “always-granted”.

At Block 1116, a request for a registered user to utilize a desired privilege is received. As earlier discussed in the context of FIG. 8, a user initiates a user request by requesting functionality via the user interface 148. The request for the desired privilege is then routed to the add-in module 122 where it is received. Add-in module 122 then seeks to determine the set of privileges available to the requesting user by first determining via the user management system the requesting user's membership in groups.

At Block 1118, a query of the privilege assignments table 196 to determine the registered user's permission to utilize the desired privilege is performed. The privilege assignments table 196 may be searched to determine the privileges assigned to the requesting user and any groups that such users are members of. As discussed above, the privilege calculator 186 may then performs its calculation on the list of retrieved privileges depending on the assignment type to determine the resulting set of available privileges for the requesting user. If the requested privilege is included in the set of available privileges for the requesting user, the privilege functionality may be performed, typically by the corresponding add-in module 122.

It will be understood by persons skilled in the art that the privileges or any functionality of add-in modules 122, along with user interface 148 representing such privileges or functionality, are provided by way of example only. It will be understood by persons skilled in the art that variations are possible in variant implementations and embodiments. Such variations include, but are not limited to, variations in the connectivity amongst described components, the sequence of execution by described components and the organization of described components.

The steps of a method in accordance with any of the embodiments described herein may be provided as executable software instructions stored on computer-readable media, which may include transmission-type media. Such steps may not be required to be performed in any particular order, whether or not such steps are described in claims or otherwise in numbered or lettered paragraphs.

The invention has been described with regard to a number of embodiments. However, it will be understood by persons skilled in the art that other variants and modifications may be made without departing from the scope of the invention as defined in the claims appended hereto.

1. A security system for use with a core application configured to interact with at least one add-in module, the add-in module being configured to provide at least one privilege, wherein the security system comprises:
(a) a privilege registry configured to identify the at least one privilege and its corresponding add-in module; and
(b) a privilege assignments table identifying a privilege assignment type for the at least one privilege and corresponding to at least one assignee.

2. The system as claimed in claim 1, wherein the privilege assignment type is selected from the group consisting of: denied, granted and always-granted.

3. The system as claimed in claim 2, wherein the privilege assignment type corresponds to the assignee's permission to utilize the corresponding privilege.

4. The system as claimed in claim 1, wherein upon installation of the add-in module, the core application is configured to determine the at least one privilege corresponding to the add-in module.

5. The system as claimed in claim 4, wherein upon determining the at least one privilege, the core application is configured to store, in the privilege registry, privilege identification data identifying the at least one privilege.

6. The security system as claimed in claim 1 further comprising an add-in module directory configured to identify the at least one add-in module.

7. The security system as claimed in claim 6, wherein upon installation of the add-in module, the security system is configured to store, in the add-in module directory, add-in module identification data identifying the add-in module.

8. The security system as claimed in claim 1, further comprising a user management system configured to identify registered users.

9. The security system as claimed in claim 8, wherein each assignee is a registered user.

10. The security system as claimed in claim 1, wherein the core application comprises an add-in module manager configured to install the at least one add-in module.

11. The system as claimed in claim 1, wherein upon receiving a user request corresponding to a registered user and to a desired privilege, the add-in module is configured to query the security system to determine the registered user's permission to utilize the privilege.

12. A method of providing security for a core application configured to interact with at least one add-in module, the add-in module being configured to provide at least one privilege, wherein the method comprises:
(a) providing a privilege registry configured to identify the at least one privilege and its corresponding add-in module; and
(b) providing a privilege assignments table identifying a privilege assignment type for the at least one privilege and corresponding to at least one assignee.

13. The method as claimed in claim 12, wherein the privilege assignment type is selected from the group consisting of: denied, granted and always-granted.

14. The system as claimed in claim 12, wherein the privilege assignment type corresponds to the assignee's permission to utilize the corresponding privilege.

15. The method as claimed in claim 12, further comprising providing a user management system configured to identify registered users.

16. The method as claimed in claim 15, wherein each assignee is a registered user.

17. The method as claimed in claim 12, further comprising:
(a) receiving a request for a registered user to utilize a desired privilege; and
(b) querying the privilege assignments table to determine the registered user's permission to utilize the desired privilege.

18. Computer readable storage storing program code which, when executed by a processor, causes the processor to perform the method of claim 12.

19. An always-granted privilege assignment type for a user rights management system,
(a) wherein an assignee is identified as a member of a first user group and a second user group;
(b) wherein the first user group is assigned the always-granted privilege assignment type for a privilege;
(c) wherein the second user group is assigned a denied privilege assignment type for the privilege;
(d) wherein the user rights management system is configured to permit the assignee to utilize the privilege despite membership in the second group.
